(19) United States
(12) Patent Application Publication
(10) Pub. No.: US 2020/0317565 A1
(43) Pub. Date: Oct. 8, 2020

(54) SOLAR-CONTROL GLAZING

(71) Applicants: AGC GLASS EUROPE, Louvain-La Neuve (BE); AGC Inc., Chiyoda-ku (JP); AGC GLASS COMPANY NORTH AMERICA, Alpharetta, GA (US); AGC VIDROS DO BRASIL LTDA, Guaratingueta (BR)

(72) Inventor: Valerie FARINA, (US)

(73) Assignees: AGC GLASS EUROPE, Louvain-La-Neuve (BE); AGC Inc., Chiyoda-ku (JP); AGC GLASS COMPANY NORTH AMERICA, Alpharetta, GA (US); AGC VIDROS DO BRASIL LTDA, Guaratingueta (BR)

(21) Appl. No.: 16/306,401

(22) PCT Filed: May 17, 2017
(86) PCT No.: PCT/EP2017/061878

§ 371 Date: Nov. 30, 2018

(51) Int. Cl. C03C 17/36

(52) U.S. Cl. CPC C03C 17/366; C03C 2217/256; C03C 17/3644; C03C 17/3649; C03C 17/3652; C03C 17/3681; C03C 2217/944; C03C 2217/74; C03C 2217/211; C03C 2217/212; C03C 2217/214; C03C 2217/215; C03C 2217/216; C03C 2217/22; C03C 2217/228; C03C 17/3642

(57) ABSTRACT

The present invention relates to solar-control glazings intended to be fitted in buildings, but also in motor vehicles. They comprise a glass substrate carrying a transparent multilayer stack comprising an alternation of n silver-based functional layers that reflect infrared radiation and of n+1 dielectric coatings, with n≥1, such that each functional layer is surrounded by dielectric coating. At least one of the dielectric coatings comprises a substantially metallic solar radiation absorbing layer based on Pd, enclosed between and in contact with two dielectric oxide layers of at least one element selected from Zn, Sn, Al, In, Nb, Ti and Zr.

### 1. FIELD OF THE INVENTION

The field of the invention is that of solar-control glazings comprising a glass substrate bearing a multilayer stack, in which at least one thin functional layer that reflects infrared radiation gives solar-control properties. This functional layer is combined with dielectric layers whose role is especially to regulate the reflection, transmission and tint properties and to ensure protection against mechanical or chemical impairment of the properties of the stack. The stack also includes a solar radiation absorbing layer whose role is to increase the solar-control properties imparted by the functional layer that reflects infrared radiation. Regulation of the thickness of this solar radiation absorbing layer makes it also possible to adjust the light absorption and the light transmission properties of the stack. These different layers are deposited, for example, by means of vacuum deposition techniques such as magnetic field-assisted cathodic sputtering, more commonly referred to as “magnetron sputtering”.

More precisely, the invention relates to glazings intended to be fitted in buildings, but also in motor vehicles. These glazing systems are generally assembled as multiple glazing units such as double or triple glazing units or even as laminated glazing units, in which the glass sheet bearing the coating stack is combined with one or more other glass sheets with or without coating, with the multilayer solar-control stack being in contact with the internal space between the glass sheets in the case of multiple glazing units, or in contact with the interlayer adhesive of the laminated unit in the case of laminated glazing units.

Solar-control glazings have a plurality of functionalities. They are used to form sun-protection glazings in order to reduce the risk of excessive temperature rise, for example, in an enclosed space with large glazed surfaces as a result of insolation and to thus reduce the power load to be taken into account for air-conditioning in summer. They are thus especially concerned with the prevention of overheating for example in the passenger compartment of a motor vehicle, in particular with respect to solar radiation passing through a transparent sunroof, or with respect to a building exposed to solar radiation when this solar radiation is sufficiently intense. In such case, the glazing must allow the least possible amount of total solar energy radiation to pass through, i.e. it must have the lowest possible solar factor (SF or g). However, it is highly desirable that it also guarantees a certain level of light transmission (LT) in order to provide a sufficient level of illumination inside the building. These somewhat conflicting requirements express the necessity to obtain a glazing unit with an elevated selectivity (S), defined by the ratio of light transmission to solar factor. In addition these glazings also have a low emissivity, which allows a reduction in the heat loss through high wavelength infrared radiation. Thus, they improve the thermal insulation of large glazed surfaces and reduce energy losses and heating costs in cold periods.

The light transmission (LT) is the percentage of incident light flux, of illuminant D65, transmitted by the glazing. The solar factor (SF or g) is the percentage of incident energy radiation, which, on the one hand, is directly transmitted by the glazing and, on the other hand, is absorbed by this and then radiated in the opposite direction to the energy source in relation to the glazing.

Glazings for buildings, but also for motor vehicles, are increasingly required to be capable of withstanding heat treatments. In some cases an operation to mechanically reinforce the glazing, such as thermal toughening of the glass sheet or sheets, becomes necessary to improve the resistance to mechanical stresses. Certain building glazings must for example undergo a toughening heat treatment to give them reinforced mechanical properties, especially to withstand heat shocks due to the temperature differences between sunlit zones and zones in shade of the same glazing installed in the facade of a building exposed to sunlight. For particular applications, it may also become necessary to give the glass sheets a more or less complex curvature by means of a bending operation at high temperature. In the processes of production and shaping of glazing systems there are certain advantages for conducting these heat treatment operations on the already coated substrate instead of coating an already treated substrate. These operations are conducted at a relatively high temperature, which is the temperature at which the functional layer based on infrared reflective material, e.g. based on silver, tends to deteriorate and lose its optical properties and properties relating to infrared radiation. These heat treatments consist in particular of heating the glass sheet to a temperature higher than 560° C. in air, e.g. between 560° C. and 700° C., and in particular around 640° C. to 670° C., for a period of about 3, 4, 6, 8, 10, 12 or even 15 minutes, depending on the type of treatment and the thickness of the sheet. In the case of a bending treatment, the glass sheet may then be bent to the desired shape. The toughening treatment then consists of abruptly cooling the surface of the flat or bent glass sheet by air jets or cooling fluid to obtain a mechanical reinforcement of the sheet.

Therefore, in the case where the coated glass sheet must undergo a heat treatment, quite specific precautions must be taken to form a coating structure that is able to withstand a thermal toughening and/or bending treatment, sometimes referred to hereafter by the term “temperable”, without losing the optical and/or energy properties it has been created for. In particular, the dielectric materials used to form the dielectric coatings must withstand the high temperatures of the heat treatment without exhibiting any adverse structural modification. Examples of materials particularly suitable for this use are zinc-tin mixed oxide, silicon nitride and aluminium nitride. It is also necessary to ensure that the functional layers that reflects infrared radiation, e.g. silver-based layers, are not oxidised during the course of the treatment, e.g. by assuring that at the instant of treatment there are barrier layers that are capable of either oxidising in place of the silver by trapping free oxygen or blocking the free oxygen migrating towards the silver during the heat treatment. And finally, it is necessary to ensure that the solar radiation absorbing layer keeps its absorption level.

The aesthetic appearance is also of great commercial importance for solar protection glazings. Specifically, not only it is necessary for the glazing to have solar-control thermal properties, it must also participate toward the aesthetic quality of the assembly of which it forms a part. These aesthetic criteria may occasionally give rise to somewhat conflicting situations as regards obtaining the desired best thermal properties. The market usually demands that glazings offer, both in transmission and in reflection, a colouring that is as neutral as possible and thus of relatively grey appearance. Slightly green or blueish colourings are also possible. However, markedly more pronounced tints, for example blue or green, are also occasionally requested to satisfy particular aesthetic criteria. The multilayer stacks, and in particular the nature, indices and thicknesses of the dielectric layers surrounding the functional layers, are chosen especially to control these colourings.

To reduce the amount of heat that penetrates into the location through the glazing, the invisible infrared heat radiation is prevented from passing through the glazing by reflecting it. This is the role of the functional layer or layers based on a material that reflects infrared radiation. This is an essential element in a sunshield multilayer structure. However, a significant portion of the heat radiation is also transmitted by visible radiation. To reduce the transmission of this portion of the heat radiation and go beyond eliminating the supply of energy by infrared radiation, it is necessary to reduce the level of light transmission. This is the role of the solar radiation absorbing layer.

### 2. SOLUTIONS OF THE PRIOR ART

The prior art generally proposes two solutions to provide solar-control stacks comprising at least one functional layer that reflects infrared radiation and a solar radiation absorbing layer. Either the solar radiation absorbing layer is substantially metallic and is arranged in the immediate vicinity of the functional layer or included in this functional layer, like in U.S. Pat. No. 8,231,977 for example, or it is metallic or nitrided and surrounded by nitride dielectric layers, like in U.S. Pat. No. 7,166,360 or WO2011133201, or still in WO2014039345, for example.

A coating stack of the type:

### Glass/ZSO5/ZSO9/Ag/Ti/ZSO5/ZSO9/Ag/Pd/Ti/ZSO9/ZSO5/TiN

according to example 2 of U.S. Pat. No. 8,231,977, wherein the solar radiation absorbing layer, i.e. Pd, is metallic and arranged in the immediate vicinity of the functional layer, has a major drawback: during heat treatment, the solar radiation absorbing material, i.e. palladium, diffuses into the silver layer and degrades silver quality, causing increased sheet resistance after heat treatment, thereby degrading the energetic performance of the heat treated stack (see also comparative example 1 hereunder).

An alternative proposed by U.S. Pat. No. 7,166,360 is to insert an absorbent layer, e.g. of TiN, into the multilayer structure and to enclose this layer between two layers of silicon nitride or aluminium nitride dielectric material. Similarly WO2011133201 proposes to insert an absorbing nitride layer of Ni and/or Cr or of Nb and/or Zr between two layers of silicon nitride. WO2014039345, on the other hand, proposes to insert an absorbing substantially metallic layer of Ni and/or Cr between two layers of silicon nitride. These solutions are somewhat complex as they further complicate the multilayer structures that are already complex in nature. In particular, they can require the use of two specific deposition zones, with adjusted atmospheres, right in the middle of a given dielectric to deposit a metallic absorbent layer and two surrounding nitride dielectric layers, in addition to one or more further deposition zone(s) with oxidising atmosphere for other oxide layers in the dielectric coating.

### 3. OBJECTS OF THE INVENTION

An object of the invention is especially to overcome these drawbacks of the prior art.

More specifically, an object of the invention is to provide a glazing equipped with a multilayer stack with solar-control properties which is capable of undergoing a high-temperature heat treatment whilst retaining its absorption properties, and therefore without deterioration of its optical quality.

Another object of the invention is to provide a glazing equipped with a multilayer stack with solar-control properties which is capable of undergoing a high-temperature heat treatment whilst retaining or even decreasing its sheet resistance, i.e. whilst not degrading its emissivity.

An object of the invention is also to provide a glazing equipped with a multilayer stack with solar-control and aesthetic properties which is capable of undergoing a high-temperature heat treatment, of toughening and/or bending type, advantageously, in some embodiments of the invention, without significant modification of light transmission.

An object of the invention is also, in at least one of its embodiments, to provide a glazing equipped with a multilayer stack which has good thermal, chemical and mechanical stability.

Another object of the invention is to provide a glazing equipped with a multilayer stack with solar-control properties which can be deposited more easily, in a single atmosphere or in at most two different atmospheres.

### 4. DESCRIPTION OF THE INVENTION

The invention relates to a transparent solar-control glazing comprising a glass substrate and a transparent multilayer stack on at least one face of the glass substrate, the transparent multilayer stack comprising an alternation of n silver-based functional layers that reflect infrared radiation and of n+1 dielectric coatings, with n≥1, such that each functional layer is surrounded by dielectric coatings, characterised in that at least one of the dielectric coatings comprises a substantially metallic solar radiation absorbing layer based on Pd, enclosed between and in contact with two dielectric oxide layers of at least one element selected from Zn, Sn, Al, In, Nb, Ti and Zr.

The presence of a solar radiation absorbing layer makes it possible to filter out the heat energy which is in the visible part of the spectrum. By combining this filtering with the reflection of the infrared radiation, obtained by means of the functional layer, solar-control glazings can be obtained that are particularly effective for preventing the overheating of premises or passenger compartments subjected to strong sunlight.

In addition, when the glazing must undergo a high-temperature heat treatment, the particular selection of palladium as absorbing element according to the invention ensures that the solar radiation absorbing layer does not significantly lose its absorption power, and thereby avoids a sharp decrease of the solar control efficiency and modification of the optical properties of the glazing. This succession of layers also allows maintaining, or even beneficially slightly reducing, the surface electrical resistance, and thus also the emissivity, following heat treatment.

Finally, as the substantially metallic solar radiation absorbing layer is sandwiched between and contacts two dielectric oxide layers, the entire dielectric coating may be deposited in only two different atmospheres, or even in a single atmosphere if ceramic oxide targets are used.

The use of oxide layers in contact with the solar radiation absorbing layer is surprising since the risk of oxidation of the absorbing layer during the heat treatment is greatly increased and there is thus a significant risk of loss of the absorption properties and/or of increase of sheet resistance, and consequently of modification of the optical properties during the treatment. It was found, surprisingly, that this is not the case when using the combination of palladium with the claimed oxide layers of at least one element selected from Zn, Sn, Al, In, Nb, Ti and Zr, and that, on the contrary, the optical quality is maintained after heat treatment.

In the rest of the description, except otherwise specified, the optical properties are defined for glazings whose substrate is made of ordinary clear “float” glass 4 mm thick. The choice of the substrate obviously has an influence on these properties. For ordinary clear glass, the light transmission through 4 mm, in the absence of a layer, is approximately 90% with 8% reflection, measured with a source conforming to the D65 “daylight” illuminant normalized by the CIE (“Commission Internationale de l'Eclairage”) and at a solid angle of 2°. The energy measurements are given according to standard EN 410. Absorption is defined through the following relation:

ABS (%)=100−LT (%)−Rg (%)

Where LT is the light transmission and Rg is the reflexion on the glass side, both measured according to standard EN 410.

For the purpose of the invention, the term “solar radiation absorbing layer” means a layer which absorbs part of the visible radiation, and which consists essentially of one or more material whose extinction coefficient k is at least 1.9, preferably at least 2.0, at a wavelength of 500 nm. And except otherwise specified, the term “based on a material” means that it comprises said material in a quantity of at least 50 Wt %, preferably at least 60 Wt %, more preferably at least 70 Wt %, still more preferably at least 80 Wt %

The solar radiation absorbing layer is based on palladium. It may further be alloyed with other absorbing material (e.g. Co, Ru, Rh, Re, Os, Ir, Pt), or doped with one or more other elements for various reasons, in particular for ease of deposition by magnetron sputtering or ease of machining the targets. Preferably it consists essentially of palladium.

It was found that palladium was particularly suitable for use in the context of the invention for combining together the optical quality after heat treatment, the energy performance qualities and the chemical and mechanical durability of the stack. Palladium has indeed revealed to be particularly stable in the presence of oxygen of the two surrounding dielectric oxide layers.

The solar radiation absorbing layer is substantially in metallic form. Although essentially in metallic form, the metal may have traces of oxidation and/or nitridation due to an oxygen and/or nitrogen contaminated deposition atmosphere.

Preferably, this layer of absorbent material has a physical thickness in the range of between 0.3 and 10 nm, advantageously in the range of between 0.4 and 5 nm, and ideally in the range of between 0.8 and 3 nm. These thickness ranges allow the formation of sunshield glazing units with a low solar factor and high selectivity with a pleasing aesthetic appearance that meets the requirement of the market.

Preferably, the light absorption, and thus the absorption of solar radiation in the visible part of the spectrum, due to the solar radiation absorbing layer, measured by depositing only this absorbing layer enclosed between its two dielectric oxide layers on ordinary clear glass 4 mm thick, is between 5% and 50%, preferably between 5% and 45%, more preferably between 10% and 35%.

Preferably, 4 to 35%, advantageously 8 to 22%, of the light absorption of the multilayer stack, whether before or after thermal treatment, is attributable to the absorbent material. The invention allows in particular the formation of a glazing after thermal treatment that has a relatively elevated absorption level with an aesthetically pleasing appearance.

The dielectric oxide layers surrounding and contacting the solar radiation absorbing layer are oxide layers of at least one element selected from Zn, Sn, Al, In, Nb, Ti and Zr, preferably selected from Zn, Sn, Ti and Zr. These oxides have the advantage of providing good deposition rates. These dielectric oxide layers are preferably layers of zinc-tin mixed oxide, more preferably a layer of zinc-tin mixed oxide containing at least 20% tin, still more preferably a layer of zinc-tin mixed oxide in which the proportion of zinc-tin is close to 50-50% by weight (Zn₂SnO₄). The two surrounding dielectric oxide layers may each have the same or a different composition. They may also be layers of substoichiometric oxide.

The dielectric oxide layers surrounding and contacting the solar radiation absorbing layer preferably have a thickness of at least 8 nm, more preferably at least 10 nm or at least 12 nm. Their thickness is preferably 80 nm at most or 70 nm at most, more preferably 60 nm at most or 55 nm at most.

The dielectric oxide layers surrounding and contacting the solar radiation absorbing layer may advantageously be deposited from a ceramic target under an inert atmosphere e.g. of argon. This may allow the sequence dielectric oxide/metallic solar radiation absorbing layer/dielectric oxide to be deposited in the same compartment or chamber of the magnetron sputtering line, under the same atmosphere, thereby avoiding separation and pumping means between the various layers deposition steps, thereby reducing the complexity of the magnetron line. In addition, ceramic targets may provide higher deposition rates. Other advantages of the surrounding ceramic oxide layers may be higher selectivity, lower emissivity and/or lower haze.

The stack may comprise a single silver-based functional layer. In this embodiment, the solar radiation absorbing layer may be placed between the substrate and the functional layer, or above the functional layer. A glazing that affords efficient sun protection and that is relatively easy to manufacture may thus be obtained.

The stack may alternatively comprise at least two silver-based functional layers that reflect infrared radiation. This embodiment makes it possible to obtain a more selective glazing, i.e. a glazing with a low solar factor, which thus prevents the entry of heat, while at the same time conserving relatively high light transmission. In particularly advantageous embodiments, the stack comprises three, or even four, silver-based functional layers. The selectivity of the glazings bearing these stacks is thus markedly improved.

When the stack comprises two silver-based functional layers, the solar radiation absorbing layer may preferably be placed either between the substrate and the first functional layer, or between the two functional layers.

In a first embodiment, the solar radiation absorbing layer is between the substrate and the first functional layer. It should be noted here that, in the solar-control glazings of the type of the invention, the multilayer stack is placed in position 2, i.e. the coated substrate is on the outer side of the premises and solar radiation passes through the substrate and then the stack. This embodiment makes it possible to obtain efficient solar-control glazings, but it nevertheless has the drawback of absorbing heat radiation quite well and thus has a tendency to heat up. In the case of glazings with low light transmission, this heating may be such that it is necessary to perform a mechanical-reinforcement heat treatment for each glazing.

Preferably, according to a second embodiment, the solar radiation absorbing layer is between the two silver-based functional layers. In this second embodiment, part of the calorific solar radiation is reflected by the first silver layer and the energy absorption of the stack is lower than in the first embodiment. Furthermore, the interior light reflection is lower, which reduces the “mirror” effect inside the premises and improves the visibility through the glazing.

When the stack comprises three functional layers, the possibility of placing the solar radiation absorbing layer between the second and the third functional layers is added to the first two embodiments. This is likewise the case when the stack comprises four functional layers, but with an additional possibility.

The infrared radiation reflecting functional layer is a silver-based layer which preferably consists of silver. For the purpose of the invention, the term “silver-based” means that the functional layer comprises silver in a quantity of at least 50 Wt %, preferably at least 60 Wt %, more preferably at least 70 Wt %, still more preferably at least 80 Wt %. Alternatively it may be doped with a doping agent in a proportion of 10% by weight at most, preferably of around 1 or 2% by weight to improve the chemical stability of the stack, but this dopant should not degrade the silver quality, which would cause increased sheet resistance after heat treatment.

The functional layer advantageously has a thickness of at least 6 nm or at least 8 nm, preferably at least 9 nm. Its thickness is preferably 22 nm at most or 20 nm at most, more preferably 18 nm. These thickness ranges may enable the desired low emissivity and anti-solar function to be achieved while retaining a good light transmission. In a coating stack with two functional layers it may be preferred that the thickness of the second functional layer, that furthest away from the substrate, is slightly greater than that of the first to obtain a better selectivity. In the case of a coating stack with two functional layers, the first functional layer may have a thickness, for example, of between 8 and 18 nm and the second functional layer may have a thickness between 10 and 20 nm.

In general, each dielectric coating may comprise one or more transparent dielectric layer usually used in the field, such as, to mention but a few TiO₂, SiO₂, Si₃N₄, SiOₓN_{y}, Al(O)N, Al₂O₃, SnO₂, ZnO, ZnAlOₓ, Zn₂SnO₄, ITO, ZrO₂, Nb₂O₅ and Bi₂O₃, a mixed oxide of Ti and of Zr or of Nb, etc. The dielectric layers are generally deposited by magnetic field-assisted (magnetron) cathodic sputtering under reduced pressure, but they may also be deposited via the well-known technique known as PECVD (plasma-enhanced chemical vapour deposition).

The dielectric coatings are preferably capable of undergoing a heat treatment imposed on the substrate coated with the multilayer stack without any significant deterioration or change in structure, and advantageously, in some embodiments of the invention, without any significant modification of the opto-energetic properties.

In particular, the first dielectric layer deposited on and in contact with the glass substrate may be a nitride, such as silicon or aluminium nitride. Alternatively, the first dielectric layer in contact with the glass substrate is a layer consisting of an oxide, and advantageously a layer of oxide of at least one element chosen from Zn, Sn, Ti and Zr, and alloys thereof. It was found that this alternative in particular improves the chemical durability of the product that has not been heat-treated. Use may be made, for example, of a layer of titanium oxide, which is especially appreciated for its high refractive index, or of a layer of mixed zinc-tin oxide, advantageously containing at least 20% tin, even more preferentially a layer of mixed zinc-tin oxide in which the zinc-tin proportion is close to 50-50% by weight (Zn₂SnO₄), which is especially appreciated for its resistance to high-temperature heat treatment.

The first dielectric layer deposited on and in contact with the glass substrate may advantageously have a thickness of at least 5 nm, preferably at least 8 nm and more preferentially at least 10 nm. These minimum thickness values make it possible, inter alia, to ensure the chemical durability of the product that has not been heat-treated, but also to ensure the resistance to the heat treatment.

Preferably, each dielectric coating comprises a layer of mixed zinc-tin oxide. The presence of this layer in each of the dielectric coatings promotes good resistance of the stack to the high-temperature heat treatment.

The dielectric coating on the outside of the multilayer stack preferably includes at least one zinc-tin mixed oxide-based layer containing at least 20% tin and/or a barrier layer to oxygen diffusion selected among the following materials: AlN, AlNₓO_{y}, Si₃N₄, SiOₓN_{y}, SiO₂, ZrN, SiC, SiOₓC_{y}, TaC, TiN, TiNₓO_{y}, TiC, CrC, DLC and alloys thereof, and nitrides or oxynitrides of alloys such as SiAlOₓN_{y} or SiTiₓN_{y}. The thus defined outer dielectric coating benefits stability of the absorbent material in particular when the multilayer stack is subjected to different chemical and thermal attacks from outside and in particular during a high-temperature thermal treatment such as bending and/or toughening. The barrier layer to oxygen diffusion in particular promotes the chemical installation, especially with respect oxygen, of the stack relative to the external atmosphere, in particular during a high-temperature heat treatment.

In addition a thin protective layer may be provided on this last dielectric coating to offer, for example, mechanical protection, for instance a thin layer of mixed titanium-zirconium oxide. The multilayer stack is advantageously finished by a protective layer comprising a final thin film of e.g. SiO₂, SiC or titanium-zirconium mixed oxide, with a thickness of 1.5 to 20 nm for example. It may also be finished by a thin carbon-based protective layer with a thickness of 1.5 to 10 nm. This protective layer, which is deposited by cathodic sputtering from a carbon target in an inert atmosphere, is suitable for protecting the lamination structure during handling, transport and storage before the thermal treatment. With respect to the use of carbon, this protective layer burns during the high-temperature thermal treatment and disappears completely from the finished product.

A protective layer, or “barrier” layer, is preferably deposited directly onto the silver-based functional layer, or onto each of the functional layers if there are several of them. It may be a metallic layer, also generally known as a “sacrificial layer” in a manner known in the field, for example a thin layer of Ti, NiCr, Nb or Ta, deposited from a metal target in an inert atmosphere and intended to preserve the silver during the deposition of the next dielectric layer, when this layer is made of oxide, and during the heat treatment. It may also be a TiOx layer deposited from a ceramic target in a virtually inert atmosphere, or a layer of NiCrOₓ.

Alternatively, the protective layer(s) deposited directly onto the silver-based functional layer(s) are made of ZnO, optionally doped with aluminium (ZnAlOₓ), obtained from a ceramic target, either doped with aluminium or sub-stoichiometric or made of pure ZnO, and deposited in a relatively inert atmosphere, i.e. an atmosphere of pure argon or optionally with a maximum of 20% oxygen. Such a layer for protecting the functional layer(s) has the advantage of improving the light transmission of the stack and has a beneficial effect on the properties of the silver-based functional layer, especially as regards the emissivity and the mechanical strength. Such a layer for protecting the functional layer also has the advantage of attenuating the risk of modification of the total light transmission during the high-temperature heat treatment. A variation in the light transmission during the heat treatment of less than 6%, preferably less than 4% and advantageously less than 2% may thus be achieved.

Each silver-based functional layer is preferably deposited onto a wetting layer, for example based on zinc oxide, possibly doped with aluminium. The crystallographic growth of the functional layer on the wetting layer is thus favourable to obtaining low emissivity and good mechanical strength of the interfaces. The wetting layer also acts favourably on the recrystallization of this functional layer during the high-temperature heat treatment.

The term “glass” is understood to denote an inorganic glass. This means a glass with a thickness at least greater than or equal to 0.5 mm and less than or equal to 20.0 mm, preferentially at least greater than or equal to 1.5 mm and less than or equal to 10.0 mm, comprising silicon as one of the essential constituents of the vitreous material. For certain applications, the thickness may be, for example, 1.5 or 1.6 mm, or 2 or 2.1 mm. For other applications, it will be, for example, about 4 or 6 mm. Silico-sodio-calcic glasses are preferred. Needless to say, the glass substrate may be a bulk-tinted glass, such as a grey, blue or green glass, to absorb even more sunlight, or to form a private space with low light transmission so as to dissimulate the passenger compartment of the vehicle, or an office in a building, from external regard, or to provide a particular aesthetic effect. The glass substrate may also be an extra-clear glass with very high light transmission. In this case, it will only absorb very little sun radiation.

The invention specifically relates to multilayer stacks, which, when deposited on an ordinary clear soda-lime float glass sheet 6 mm thick, provide a solar factor SF of less than 45%, in particular of 20 to 45%, preferably in the range of between 20 and 40%. They advantageously provide a light transmission LT of less than 72%, in particular of 20 to 70%, preferably in the range of between 35 and 68%.

The invention covers a transparent solar-control glazing as described above, which has or has not undergone a toughening and/or bending type heat treatment after deposition of the multilayer stack.

The invention also covers a laminated glazing comprising a transparent glazing according to the invention as described above, which has or has not undergone a toughening and/or bending thermal treatment after deposition of the multilayer stack, the multilayer stack of which may be in contact with the thermoplastic adhesive material connecting the substrates, generally PVB.

The invention also covers an insulating multiple glazing comprising a transparent glazing according to the invention as described above, which has or has not undergone a toughening and/or bending thermal treatment after deposition of the multilayer stack, for example a double or triple glazing with the multilayer stack arranged facing the closed space inside the multiple glazing.

Preferably, the solar factor SF or g, measured according to standard EN410, is between 12% and 40%, advantageously between 20% and 36%, for a 6/15/4 double glazing made of clear glass. The double glazing is thus formed from a first sheet of ordinary sodio-calcic clear glass 6 mm thick bearing the multilayer stack in position 2, i.e. on the inner face of the double glazing, separated from another sheet of clear glass 4 mm thick, without a stack, by a closed space 15 mm thick filled with 90% argon. Such a double glazing allows very effective solar control.

Preferably, in multiple glazing, the selectivity, expressed in the form of the light transmission LT relative to the solar factor g, is at least 1.4 or at least 1.5, advantageously at least 1.6 or 1.7, preferentially at least 1.75 or 1.8. A high selectivity value means that, despite an efficient solar factor which greatly reduces the amount of calorific energy coming from the sun and penetrating into the premises via the glazing, the light transmission remains as high as possible to enable lighting of the premises.

Preferably, the multiple glazing according to the invention has a solar factor SF in the range of between 15 and 40%, a light transmission of at least 30% and a colour that is relatively neutral in transmission and neutral to slightly bluish in reflection on the side of the glass sheet bearing the lamination structure. Preferably, the multiple glazing according to the invention has a solar factor SF in the range of between 15 and 45%, advantageously between 20 and 40%, with a light transmission of at least 30%. This multiple glazing has particularly beneficial sunshield properties in relation to its relatively high light transmission, while still having an aesthetic appearance that enables it to be easily integrated into an architectural assembly.

### 5. DESCRIPTION OF PREFERRED EMBODIMENTS OF THE INVENTION

The invention will now be described in more detail in a non-restrictive manner by means of the following preferred exemplary embodiments. Examples of multilayer stacks deposited on a glass substrate to form glazings according to the invention, but also comparative examples (“C”), are given in tables 1 to 3 below. The layers are in order, from left to right, starting from the glass.

The various layers are applied via a cathodic sputtering technique under usual conditions for this type of technique. The metallic layers are deposited in an inert atmosphere of argon. The oxide layers denoted “ceram” are deposited, from a ceramic target under an inert atmosphere of argon. The other oxides are deposited from a metallic target under a reactive atmosphere of oxygen and argon.

Comparative example 1 shows a coating stack of the prior art type wherein the solar radiation absorbing layer is metallic and arranged in the immediate vicinity of the functional layer. This comparative example shows that palladium is a good candidate as temperable absorber because it maintains its absorption properties after heat treatment (ratio ABS well above 0.5). However in this particular case the sheet resistance after heat treatment, and so the emissivity, is greatly increased (ratio R/□=2.0), which unacceptably degrades the energetic performance of the glazing. This is due to the diffusion of palladium into the silver layer, degrading its quality. Note that emissivity values may be calculated from sheet resistance measurements for coating stacks including a single silver layer, with the following formula: E=R/□*1.1/100.

Comparative examples 2 to 8 disclose various other materials for the absorbing layer. All these comparative examples show a huge loss of their absorption properties after heat treatment (ratio ABS below 0.5). Comparative example 7, in addition, shows a very much degraded sheet resistance.

On the other hand examples 1 to 5, shows that palladium maintains its absorption properties after heat treatment and that the sheet resistance may at least be maintained or even improved, when palladium is not in close proximity with the silver layer, but surrounded by oxide layers. In addition, when comparing example 2 to example 1 and example 4 to example 3, it can be seen that using oxide layers deposited from ceramic targets as oxide layers surrounding palladium further decrease the sheet resistance after heat treatment.

The coating stacks described in table 2 are an attempt to provide a range of solar control glazings with luminous transmissions in double-glazing of around 40, 50 and 60%, using palladium between oxide layers. These double-glazings include a first pane made of a 6 mm thick mid-iron glass coated with the defined coating stack which has been heat-treated, a second pane made of a 4 mm thick clear glass, and a 15 mm thick spacing between the two panes filled with 90% argon. Light transmission, solar factor and selectivity values are given.

Small samples of these coating stacks deposited on a 4 mm-thick glass where heat treated in a static lab furnace at 670° C. during increasing durations from 6 to 9 minutes, while 6 minutes is considered as standard duration for a 4 mm-thick glass sheet. Table 2 shows the haze level from 0 (perfect) to 5 (bad). Whilst a haze level of less than 3 is acceptable, a haze level of 3 or 3,5 is borderline and a haze level of 4 or more is unacceptable. These results show that the haze level of stacks including the succession oxide/Pd/oxide are generally low even with longer heat treatments, showing their thermal stability.

The overall chemical and mechanical durability of these coating stacks is good, i.e. similar to other known solar-control stacks of this type.

Table 3 shows the advantages of using oxide layers deposited from ceramic targets as oxide layers surrounding palladium. These double-glazings include a first pane made of a 6 mm thick mid-iron glass coated with the defined coating stack which has been heat-treated, a second pane made of a 4 mm thick mid-iron glass, and a 15 mm thick spacing between the two panes filled with 90% argon. Light transmission, solar factor, selectivity and haze values are given.

When comparing example 10 with example 9, it can be seen that using oxide layers deposited from ceramic targets as oxide layers surrounding palladium provides better selectivity and decreased emissivity. When comparing example 11 with example 12, it can be seen that using oxide layers deposited from ceramic targets as oxide layers surrounding palladium provides a better haze value.

As already said, the present invention has the additional advantage that multilayer solar-control stacks can be deposited in a single atmosphere, using ceramic oxide targets. The following examples of coating stacks can be deposited in a full argon atmosphere (same nomenclature as for Tables 1-3).

| | | | | | | | |
|---|---|---|---|---|---|---|---|
| ZSO5 ceram | Pd | ZSO5 ceram | ZnO ceram | Ag | AZO | ZSO5 ceram | TiO₂ ceram |

| | | | | | | | | | | | |
|---|---|---|---|---|---|---|---|---|---|---|---|
| ZSO5 | ZnO | Ag | AZO | ZSO5 | Pd | ZSO | ZnO | Ag | AZO | ZSO5 | TZO |
| ceram | ceram | | | ceram | | ceram | ceram | | | ceram | |

| | | | | | | | | | | | | |
|---|---|---|---|---|---|---|---|---|---|---|---|---|
| ZSO5 | AZO | Ag | Ti | ZSO5 | Pd | ZSO | AZO | Ag | Ti | ZSO5 | Ti | C |
| ceram | | | | ceram | | ceram | | | | ceram | | |

TABLE 1

| | | | | | | | | | ABS | ABS | ratio | R/□ | | ratio |
|---|---|---|---|---|---|---|---|---|---|---|---|---|---|---|
| | | | | | | | | | BB | AB | ABS | BB | R/nAB | R/□ |
| C1 | ZSO5 | ZnO | Ag | Pd | Ti | ZSO5 | TiO₂ | | | | | | | |
| | 300 | 100 | 110 | 20 | 50 | 300 | 50 | | 34.7 | 32.4 | 0.9 | 4.0 | 8.0 | 2.0 |
| C2 | ZSO5 | Cr | ZSO5 | ZnO | Ag | Ti | ZSO5 | TiO₂ | | | | | | |
| | ceram | | ceram | ceram | | | ceram | | | | | | | |
| | 150 | 20 | 150 | 100 | 110 | 50 | 300 | 50 | 50.1 | 5.9 | 0.1 | 5.3 | 3.2 | 0.6 |
| C3 | ZSO5 | NiCr | ZSO5 | ZnO | Ag | AZO | ZSO5 | SiN | | | | | | |
| | 200 | 13.7 mg/m² | 150 | 50 | 100 | 50 | 150 | 150 | 12.4 | 5.53 | 0.4 | 5.2 | 3.4 | 0.6 |
| C4 | ZSO5 | NiCr | ZSO5 | ZnO | Ag | AZO | ZSO5 | SiN | | | | | | |
| | ceram | | ceram | | | | | | | | | | | |
| | 200 | 10.8 mg/m² | 150 | 50 | 100 | 50 | 150 | 150 | 14.8 | 5.6 | 0.4 | 4.1 | 2.8 | 0.7 |
| C5 | ZSO5 | NiCrW | ZSO5 | ZnO | Ag | AZO | ZSO5 | SiN | | | | | | |
| | ceram | | ceram | | | | | | | | | | | |
| | 200 | 15 | 150 | 50 | 100 | 50 | 150 | 150 | 15.2 | 5.86 | 0.4 | 4.0 | 2.7 | 0.7 |
| C6 | ZSO5 | ZnO | Ag | Ti | ZSO5 | NiV | ZSO5 | TiO₂ | | | | | | |
| | | | | | ceram | | ceram | | | | | | | |
| | 205 | 50 | 100 | 50 | 150 | 18.5 mg/m² | 150 | 50 | 39.6 | 5.8 | 0.1 | 6.4 | 6.4 | 1.0 |
| C7 | ZSO5 | ZnO | Ag | Ti | ZSO5 | Cu | ZSO5 | TiO₂ | | | | | | |
| | 205 | 50 | 100 | 50 | 150 | 75 mg/m² | 150 | 50 | 80.8 | 20.7 | 0.3 | 4.5 | 32.7 | 7.2 |
| C8 | ZSO5 | ZnO | Ag | Ti | ZSO5 | NiV—Cu | ZSO5 | TiO₂ | | | | | | |
| | 205 | 50 | 100 | 50 | 150 | NiV: 18.5 mg/m² | 150 | 50 | 35.8 | 7.8 | 0.2 | 7.3 | 6.4 | 0.9 |
| 1 | ZSO5 | ZnO | Ag | Ti | ZSO5 | Pd | ZSO5 | TiO₂ | | | | | | |
| | 205 | 50 | 100 | 50 | 150 | 25 | 150 | 50 | 36.3 | 27.7 | 0.8 | 5.5 | 5.1 | 0.9 |
| 2 | ZSO5 | ZnO | Ag | Ti | ZSO5 | Pd | ZSO5 | TiO₂ | | | | | | |
| | | | | | ceram | | ceram | | | | | | | |
| | 205 | 50 | 100 | 50 | 150 | 25 | 150 | 50 | 39.6 | 25.8 | 0.7 | 6.4 | 4.5 | 0.7 |
| 3 | ZSO5 | Pd | ZSO5 | ZnO | Ag | AZO | ZSO5 | SiN | | | | | | |
| | 200 | 30 | 150 | 50 | 100 | 50 | 150 | 150 | 30.0 | 30.4 | 1.0 | 5.1 | 3.4 | 0.7 |
| 4 | ZSO5 | Pd | ZSO5 | ZnO | Ag | AZO | ZSO5 | SiN | | | | | | |
| | ceram | | ceram | | | | | | | | | | | |
| | 200 | 30 | 150 | 50 | 100 | 50 | 150 | 150 | 30.6 | 30.4 | 1.0 | 4.4 | 2.6 | 0.6 |
| 5 | ZSO5 | Pd | ZSO5 | ZnO | Ag | Ti | ZSO5 | TiO₂ | | | | | | |
| | ceram | | ceram | | | | | | | | | | | |
| | 150 | 20 | 150 | 100 | 110 | 50 | 300 | 50 | 45.5 | 30.6 | 0.7 | 4.5 | 2.8 | 0.6 |

TABLE 2

| | | | | | | ZSO5 | | ZSO5 | | | | |
|---|---|---|---|---|---|---|---|---|---|---|---|---|
| | ZSO5 | ZnO | Ag | Ti | ZSO5 | ceram | Pd | ceram | ZSO5 | ZnO | Ag | Ti |
| 6 | 205 | 50 | 127 | 50 | 36 | 150 | 10.1 | 150 | 400 | 50 | 146 | 50 |
| 7 | 230 | 50 | 134 | 50 | 305 | 150 | 19.2 | 150 | 156 | 50 | 174 | 50 |
| 8 | 230 | 50 | 151 | 50 | 322 | 150 | 25.9 | 150 | 165 | 50 | 187 | 50 |

| | | | | | | | haze after | | |
|---|---|---|---|---|---|---|---|---|---|
| | | | | | | | 6 | 7 | 8 |
| | ZSO5 | TiN | C | LT | SF | S | min | min | min |
| 6 | 327 | ~35 | ~60 | 62.0 | 35.2 | 1.76 | 2 | 3 | 3 |
| 7 | 323 | ~35 | ~60 | 49.0 | 27.5 | 1.78 | 2 | 2.5 | 2 |
| 8 | 333 | ~35 | ~60 | 40.1 | 22.4 | 1.79 | 2 | 3 | 3.5 |

TABLE 3

| | | | | | | ZSO5 | | ZSO5 | | | | | | | | | | | | |
|---|---|---|---|---|---|---|---|---|---|---|---|---|---|---|---|---|---|---|---|---|
| | ZSO5 | ZnO | Ag | Ti | ZSO5 | ceram | Pd | ceram | ZSO5 | ZnO | Ag | Ti | ZSO5 | TiN | C | LT | SF | S | E | haze |
| 9 | 230 | 50 | 154 | 55 | 425 | — | 25.9 | — | 360 | 50 | 190 | 55 | 307 | ~35 | ~60 | 36.8 | 21.4 | 1.72 | 0.017 | |
| 10 | 230 | 50 | 151 | 50 | 250 | 150 | 25.9 | 150 | 165 | 50 | 187 | 50 | 315 | ~35 | ~60 | 38.0 | 21.3 | 1.79 | 0.011 | |
| 11 | 230 | 50 | 151 | 55 | 405 | — | 25.9 | — | 335 | 50 | 187 | 55 | 310 | ~35 | ~60 | — | — | — | — | 4 |
| 12 | 230 | 50 | 151 | 50 | 322 | 150 | 25.9 | 150 | 165 | 50 | 187 | 50 | 333 | ~35 | ~60 | — | — | — | — | 2 |

Tables legend

| | |
|---|---|
| ABS BB | luminous absorption “before bake”, i.e. before heat-treatment, expressed in % |
| ABS AB | luminous absorption “after bake”, i.e. after heat-treatment, expressed in % |
| ratio ABS | =ABS AB/ABS BB |
| R/□ BB | sheet resistance “before bake”, i.e. before heat-treatment, expressed in Ω/□ |
| R/□ AB | sheet resistance “after bake”, i.e. after heat-treatment, expressed in Ω/□ |
| ratio R/□ | =R/□ AB/R/□ BB |
| LT | light transmission |
| SF | solar factor, expressed in % |
| S | selectivity, expressed in % |
| ZSO5 | Mixed zinc-tin oxide (zinc stannate Zn₂SnO₄) formed from a cathode of a zinc-tin |
| | alloy containing 52 Wt % zinc and 48 Wt % tin, under an oxidising atmosphere |
| ZSO5 ceram | Mixed zinc-tin oxide (zinc stannate Zn₂SnO₄) formed from a ceramic cathode of |
| | a 52/48 zinc-tin oxide, under an inert atmosphere of argon |
| ZnO | Oxide of zinc deposited from a metallic target of zinc under an oxidising |
| | atmosphere |
| ZnO ceram | Oxide of zinc deposited from a ceramic target of zinc oxide in an inert |
| | atmosphere of argon |
| NiCr | Alloy of 80/20 nickel/chromium |
| NiCrW | Alloy of 80/20 nickel/chromium (50 Wt %) and of W (50 Wt %) |
| AZO | Mixed oxide of zinc and aluminium, deposited from a ceramic target of zinc |
| | oxide doped with 2 Wt % aluminium, under an inert atmosphere of argon |
| SiN | Silicon nitride without representing a chemical formula, it being understood |
| | that the products obtained are not necessarily rigorously stoichiometric. The |
| | SiN layers may contain up to a maximum of about 10% by weight of aluminium |
| | originating from the target. |
| NiV | Alloy resulting of the sputtering of a 93/7 nickel/vanadium target in an argon |
| | atmosphere |
| NiV—Cu | Alloy resulting of the co-sputtering of a 93/7 nickel/vanadium target and of a |
| | copper target in an argon atmosphere, to get into the layer a proportion of |
| | 90 Wt % NiV and 10 Wt % Cu |
| TZO | Mixed oxide comprising 50% TiO₂ and 50% ZrO₂ |

absorbing materials in the stacks are in bold
poor results are in bold and underlined
except specified otherwise, all thicknesses are expressed in Å
* value expressed in inch/minute, when power = 0.2 kW, pressure = 3.7 mTorr, under 100% Ar

1. A transparent solar-control glazing comprising a glass substrate and a transparent multilayer stack on at least one face of the glass substrate, the transparent multilayer stack comprising an alternation of n silver-based functional layers that reflect infrared radiation and of n+1 dielectric coatings, with n≥1, such that each functional layer is surrounded by dielectric coatings, wherein at least one of the dielectric coatings comprises a substantially metallic solar radiation absorbing layer based on Pd, enclosed between and in contact with two dielectric oxide layers of at least one element selected from the group consisting of Zn, Sn, Al, In, Nb, Ti and Zr, said dielectric oxide layers having a thickness of at least 8 nm.

2. The transparent solar-control glazing of claim 1, wherein the solar radiation absorbing layer consists essentially of palladium.

3. The transparent solar-control glazing of claim 1, wherein the solar radiation absorbing layer has a thickness between 0.3 and 10 nm.

4. The transparent solar-control glazing of claim 1, wherein the dielectric oxide layers surrounding and contacting the solar radiation absorbing layer are deposited from a ceramic target.

5. The transparent solar-control glazing of claim 1, wherein the dielectric oxide layers surrounding and contacting the solar radiation absorbing layer have a thickness between 8 and 80 nm.

6. The transparent solar-control glazing of claim 1, wherein the multilayer stack comprises at least two silver-based functional layers that reflect infrared radiation.

7. The transparent solar-control glazing of claim 1, wherein the solar radiation absorbing layer is placed between two silver-based functional layers that reflect infrared radiation.

8. The transparent solar-control glazing of claim 1, further comprising a barrier layer above and in contact with a silver-based functional layer, said barrier layer being a metallic sacrificial layer or an oxide layer deposited from a ceramic target.

9. The transparent solar-control glazing of claim 1, further comprising a wetting layer under and in contact with a silver-based functional layer.

10. The transparent solar-control glazing of claim 1, having a light transmission LT between 20% and 70%.

11. A laminated glazing, comprising the transparent solar-control glazing of claim 1.

12. An insulating multiple glazing, comprising the transparent solar-control glazing of claim 1.

13. The insulating multiple glazing of claim 12, wherein a solar factor SF, measured according to standard EN410, is between 12% and 40% for a 6/15/4 double glazing made of clear glass.

14. The insulating multiple glazing of claim 13, wherein a selectivity, expressed in the form of the light transmission LT relative to the solar factor SF, is at least 1.4.
